(19) United States
(12) Patent Application Publication
(10) Pub. No.: US 2006/0168060 A1
(43) Pub. Date: Jul. 27, 2006

(54) Instant message filtering method

(75) Inventors: Olivier Briand, Caen (FR); Vincent Auvray, Caen (FR); Nicolas Baupin, Ranville (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 11/258,515

(22) Filed: Oct. 25, 2005

(30) Foreign Application Priority Data
Oct. 26, 2004 (FR) 0411395

(51) Int. Cl. G06F 15/16

(52) U.S. Cl. 709/206

(57) ABSTRACT

The invention relates to a method of filtering messages in an instant messaging server comprising a main instant messaging module connected to an information base containing instant messaging clients' contact lists with associated filtering rules, said method comprising the following steps: a) a first instant messaging client sending a messaging whereof the addressee is a second instant messaging client; b) consulting the contact list of the second instant messaging client to verify if filtering of messages from the first instant messaging client is specified in said list; c) in the event of positive verification, replacing the addressee of the message by a third instant messaging client and forwarding the message to that third instant messaging client; or d) in the event of negative verification, sending the message to the second instant messaging client.

### FIELD OF THE INVENTION

The field of the present invention is that of instant messaging. It relates more particularly to filtering messages in an instant messaging system.

### PRIOR ART

Instant messaging enables users to exchange messages in real time. FIG. 4 shows a simplified example of a standard instant messaging system which comprises an instant messaging server 100 to which two users A and B are connected via respective instant messaging clients C_A and C_B. The server 100 comprises a main instant messaging module 110 for managing the presence of instant messaging clients and the exchange of messages between them as a function of instant message routing rules. This module also manages each instant messaging client's lists of contacts 120, known as “buddy lists”, such as the lists 121 and 122 corresponding to the contact lists of users A and B, respectively.

The state of presence/availability of a user is a dynamic parameter visible to other users. This state may generally vary between an “on line” state and an “away” state or between an “available” state and a “busy” state. These presence states define the user's communication capacity for the whole of the contact list. It is the user who decides this presence state.

In FIG. 4, the user B wishes to communicate with the user A by means of instant messages, and first consults the state of presence of the user A as indicated in his contact list 121. If the user A has set his presence parameter to “available”, for example, the user B knows that he can send the user A a message immediately and enter into communication with him. On the other hand, if the state of presence of the user A as indicated in the contact list of B corresponds to “away” or “busy”, the user B knows that the user A is temporarily unavailable and will not respond immediately.

At present, an instant messaging user can be “busy” either totally or partly. When partly busy, the user may be “busy” for 90% of his contact list, for example, and “available” for the remaining 10%. This differentiated availability management concept enables a user to choose, for a given period, contact(s) from the list with whom he is willing to communicate.

However, although this function proves useful for indicating to contacts who are temporarily “undesirable” that the user is “busy”, it cannot prevent them sending the user messages anyway. This situation may arise, for example, if a contact has not noticed that, for him, the user is temporarily “busy”, or simply in the event of an urgent message. Accordingly, during communication with selected contacts, a user has no way of forwarding to a third party messages received from other persons from his contact list, and will therefore have to deal with such messages subsequently, as in standard electronic messaging (i.e. non-instant messaging); this goes against the very principle of instant messaging, whereby messages (query/responses) are exchanged in real time.

In a business context, where the use of instant messaging is becoming more and more prevalent, whether within the business or with outsiders (e.g. customers and suppliers), the impossibility of having some received messages processed in real time by a third party, for example a co-worker or a secretary, is becoming a major inconvenience. From the point of view of establishing and maintaining relationships in a business context, giving someone an instant messaging address and then failing to respond immediately to messages they send is not viable. Instant messaging is perceived as a way of communicating in real time, like the telephone.

Consequently, there is an increasing demand for solutions for filtering and forwarding messages in the manner of the secretary filtering function well known in the field of telephony.

### SUBJECT MATTER AND BRIEF DESCRIPTION OF THE INVENTION

The present invention aims to solve the above-mentioned problems and to propose a technical solution enabling some or all of the messages received in an instant messaging system to be filtered and forwarded to a third party.

These aims are achieved by a method of filtering messages in an instant messaging server comprising a main instant messaging module connected to an information base containing instant messaging clients' contact lists with associated filtering rules, said method comprising the following steps:

a) a first instant messaging client sending a message whereof the addressee is a second instant messaging client;

b) consulting the contact list of the second instant messaging client to verify if filtering of messages from the first instant messaging client is specified in said list;

c) in the event of positive verification, replacing the addressee of the message by a third instant messaging client and forwarding the message to that third instant messaging client; or

d) in the event of negative verification, sending the message to the second instant messaging client.

Thus the filtering method of the present invention enables an instant messaging user to activate filters in respect of instant messaging clients in his contact list from whom he does not wish to receive messages. Filtered messages, i.e. messages that are not received by the user who has activated the filters, are furthermore redirected (i.e. rerouted) to a third party selected by that user, which avoids leaving the filtered messages with no response.

More particularly, the instant messaging server further comprises a filter module which, in the step b), sends a query to the main instant messaging module to determine the filtering rules present in the contact list of the second instant messaging client. Filtering rules are defined for each instant messaging client from whom instant messages are to be filtered and indicate that a filter is activated for that client and the instant messaging client to whom the messages must be forwarded.

Accordingly, in the step c), the third instant messaging client replacing the addressee of the message is determined as a function of filtering rules specified in the contact list of the second instant messaging client.

In the step c), the filter module modifies the content of the message to inform the third instant messaging client of the change of addressee.

The steps a) to d) described above may be repeated recursively as a function of the filtering rules of the third instant messaging client. To be more precise, after the steps a) to c) have been executed for the first time in the manner described above, the second instant messaging client to whom the message from the first instant messaging client has been filtered is considered, for a new series of steps a) to d), as “the first instant messaging client”, and the third instant messaging client is considered as “the second messaging client”, who is the new addressee of the filtered message.

Consequently, after the message has been filtered to the third instant messaging client, the process reverts to the step a) with: “first instant messaging client”=second instant messaging client (i.e. new sender after filtering), “second instant messaging client”=third instant messaging client (i.e. new addressee after filtering) and: “message”=filtered message. Accordingly, during a new step b), the contact list of the third instant messaging client is consulted to verify whether it specifies filtering of messages from the second instant messaging server. In the event of a positive verification result, a new step c) is executed to replace the addressee of the message by another instant messaging client specified in the filtering rules for the contact list of the third instant messaging client. These steps are repeated until no more filtering rules are found for messages coming from the “first instant messaging client” in the contact list of the messaging client indicated as the addressee of the message, which then corresponds to executing the step d).

In the step c), the filtering module sends the message to the main instant messaging module, which forwards said message to the addressee finally indicated therein.

The content of the message is modified only once, during the first filtering. It is modified to inform the new addressee that the message is not for him directly; this information is valid for all subsequent addressees if further filtering is applied in the manner described above.

The present invention also provides an instant messaging sever comprising a main instant messaging module for managing the exchange of instant messages between instant message clients, wherein said main module is connected to an information base containing instant messaging clients' contact lists and associated filtering rules and further comprises a filter module for filtering messages sent by a first instant messaging client to a second instant messaging client and for forwarding said messages to a third instant messaging client.

The technical solution proposed by the invention for filtering messages in an instant messaging server necessitates no modification of the main messaging module. Consequently, this solution can easily be integrated into existing instant messaging servers.

The third instant messaging client, to whom the messages sent by the first instant messaging clients are forwarded, is determined as a function of the filtering rules specified in the base containing the contact lists and the filtering rules associated with the second instant messaging client.

According to one aspect of the invention, the filter module further comprises means for modifying the content of a forwarded message to inform the third instant messaging client of the change of addressee. As explained above, the content of the message is modified only once, during the first filtering.

The third instant messaging client may also have specified a filter for messages sent by the second instant messaging client substituted for the sender (the first instant messaging client) during filtering. As a general rule, for each addressee indicated in the instantaneous message (i.e. the initial addressee and the forwarding addressee(s)), the filter module consults the main instant messaging module until the main module finds no more filters that apply to the last instant messaging client that filtered the message.

The invention further provides an instant messaging system comprising at least three instant messaging clients connected to at least one instant messaging server as described above.

In order to activate the filters and to set the parameters of the associated instantaneous messaging client filtering rules, the instantaneous messaging clients comprise interface means for configuring at least one filter in their respective contact list.

### BRIEF DESCRIPTION OF THE DRAWINGS

Other features and advantages of the invention will emerge from the following description of particular embodiments of the invention provided by way of non-limiting example, said description referring to the appended drawings, in which:

FIG. 1 is a diagrammatic overview of one embodiment of the instant messaging system of the invention;

FIG. 2 shows an example of setting instant messaging client filter parameters in accordance with the method of the invention;

FIG. 3 shows an example of an instantaneous message that has been filtered and forwarded to a third party in accordance with the invention; and

FIG. 4 is a diagram of a prior art instant messaging system.

### DETAILED DESCRIPTION OF EMBODIMENTS OF THE INVENTION

The invention applies to instant messaging systems and proposes to integrate functions, essentially software functions, into the instant messaging servers usually employed for instantaneous exchange of messages between users. The proposed new functions are compatible with current instant messaging service standards and protocols and can be integrated into new instant messaging servers and into servers already installed.

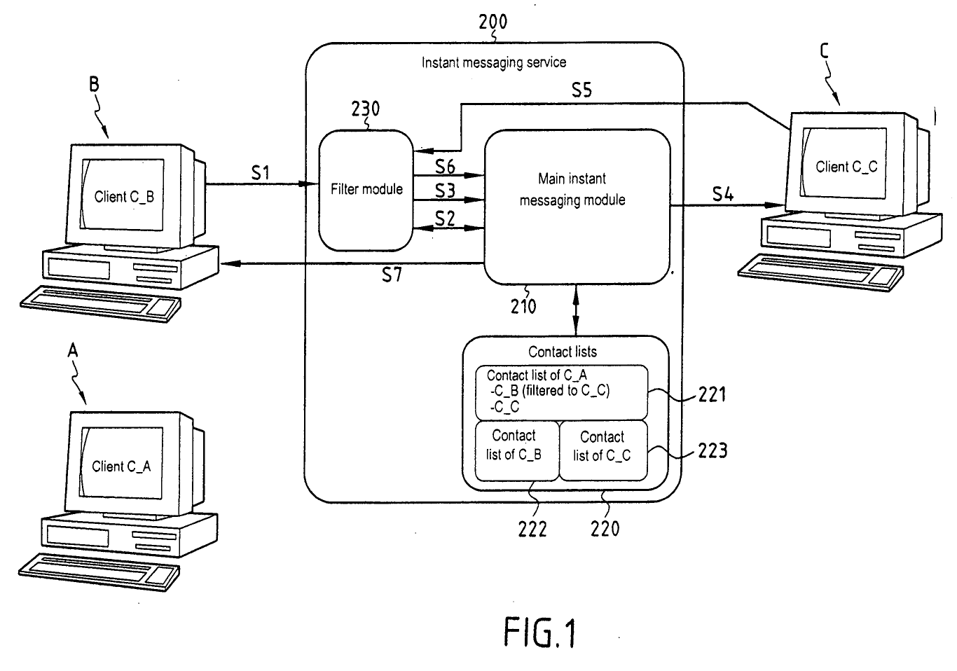

FIG. 1 is a diagrammatic overview of a system of the invention showing the various portions thereof operative in the method of the invention. The portions that are operative mainly during filtering comprise three users A, B and C, each of whom has a terminal comprising a respective instant messaging client C_A, C_B and C_C, and an instant messaging server 200. The instant messaging client (or user agent) software enables a user to access an instant messaging service via a server using a specific identifier. This is known in the art. The instant messaging client is used in particular to compose and receive messages. It also enables the user to access the instant messaging server to manage his contact list.

To avoid burdening the description of the invention unnecessarily, the invention is described with reference to an instant messaging system in which users employ as their terminal for sending and receiving messages a fixed terminal in the form of a personal computer connected to an electronic data processing network. The present invention nevertheless applies generally to all terminals that comprise means for sending and receiving instant messages via a communication network (e.g. mobile telephones and personal digital assistants).

The communication network (not shown) via which the user terminals are connected to the instant messaging server may be an “open” network, such as the Internet, a “closed” network, such as an Intranet business network, or a “partially open” network (i.e. one using a closed network and an open network at the same time).

The instant messaging server 200 enables the instantaneous exchange of messages between two users who are seen by the server as uniquely defined by their identifier. The instant messaging server 200 comprises a main instant messaging module 210, a contact list and associated filtering rule module 220, and a filter module 230.

The main instant messaging module 210, which is a software element of an instant messaging server known in the art (transfer agent), provides presence management and exchange of messages between the instant messaging clients as a function of instant message routing rules. It also manages contact lists.

The module 220 is an information base that is an integral part of the instant messaging server and contains the contact lists of each messaging client; in the present example these are the contact lists 221, 222, 223 of the clients C_A, C_B and C_C, respectively. According to the present invention, the contact lists contain additional information that corresponds to message filtering rules, as explained in more detail below.

The message filtering module 230 is specific to the present invention. It consults the filtering information (i.e. the filtering rules) present in the contact lists via the main module 210. To be more precise, the filter module 230 filters instant messages using the method of the invention. To this end, it exchanges information with the main instant messaging module 210. All the messages coming from an instant messaging client pass first through the filter module 230, which processes them before forwarding them to the main module 210.

For simplicity, the FIG. 1 system represents the minimum configuration in which the filtering method of the invention may be implemented, namely that of three users A, B and C, with the user B seeking to send a message to the user A, who has decided to forward all messages from the user B to a third user C. Nevertheless, given the description provided below, the person skilled in the art will find no difficulty in envisaging the implementation of a system of this kind on a larger scale, i.e. with a greater number of users.

The filter module 230 may be coded in a language such as C++ or Java. It can therefore be integrated into the architecture of an instant messaging server (e.g. Jabber) and in this case use the standardized extensible Messaging and Presence Protocol (XMPP), which is an instant messaging protocol based on XML. If the filter module of the invention is integrated into an instant messaging server, whether it is one that exists already or a new one, it must use a protocol compatible with that used by the main module of the instant messaging server.

The filter module 230 is on the upstream side of the main instant messaging module 210 for the instant messaging clients C_A, C_B and C_C. It scrutinizes the addressee of all messages reaching the server. For each message incoming from an instant messaging client, the filter module consults the main module 210 to look up the filtering rules present in the contact list of the addressee. The header and the body of the message are modified if the addressee has specified a filtering option in his contact list in relation to the sender of the message (e.g. if the user A has activated a filter for messages coming from the user B that forwards them to the user C). In the header, the addressee of the message is replaced by the person in his contact list to whom he has decided to forward these messages. The body of the message is modified to indicate in the text of the message that the addressee has changed. The initial addressee of the message (the user A) may optionally be notified that the user B has attempted to contact him.

In all cases, the message is sent to the main instant messaging module 210, which forwards it to the addressee indicated in the message, who is either the original addressee or a modified addressee if filtering is applied.

The filter module 230 is connected to the instant messaging clients C_A, C_B and C_C that send instant messages and to the main instant messaging module 210.

The user sets the parameters of a filter in his contact list directly in the instant messaging server, by means of his instant messaging client, which sends the instant messaging server a request to specify a filter in the contact list. This request passes through the filter module to the main instant messaging module, which effects the required modifications in the contact list. Thus according to the invention, specifying a filter and setting its parameters do not necessitate modification of the main instant messaging module. In the present invention instant messages are filtered by a specific filter module on the basis of an advanced contact list that contains filtering indications (i.e. associated filtering rules) for certain contacts as well as the new addressee for each filtered message.

The contact list with associated filtering rules of the user A from FIG. 1 may take the following form, for example:

User N (available)

User B (filtered to user C)

User C (available)

The corresponding request for defining a contact list with associated filtering rules of the above kind in accordance with the XMPP protocol is written:

```
<root>
<query xmins=’jabber:iq.roster’>
<item  jid=’userN@francetelecom.fr’
    subscription=’both’
name =’userN’><group>GROUP1</group></item>
<item  jid=’userB@francetelecom.fr’
    subscription=’both’
name=’userB’><group>GROUP2</group>
<filter>userC@francetelecom.fr</filter></item>
<item  jid=’userC@francetelecom.fr’
    subscription=’both’
name=’userC’><group>GROUP2</group></item>
</query>
</root>
```

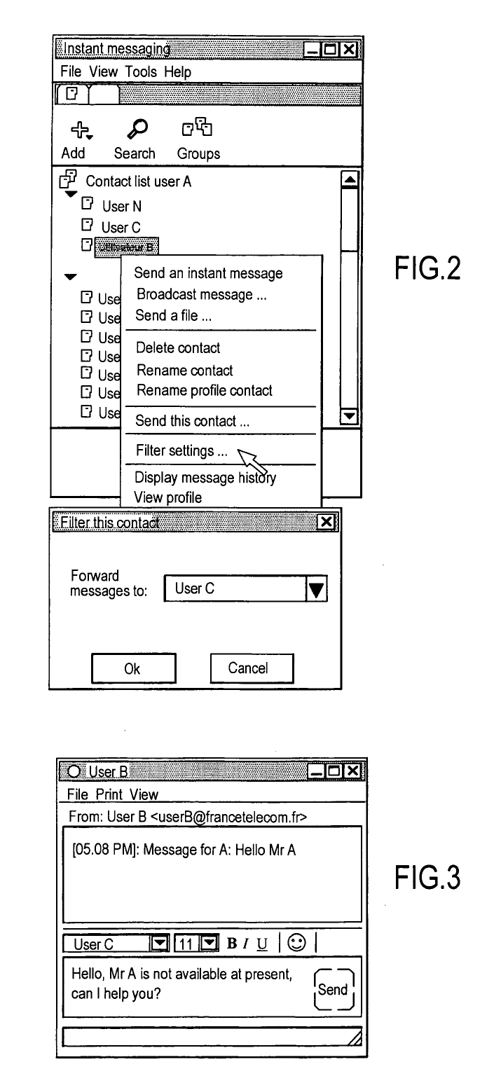

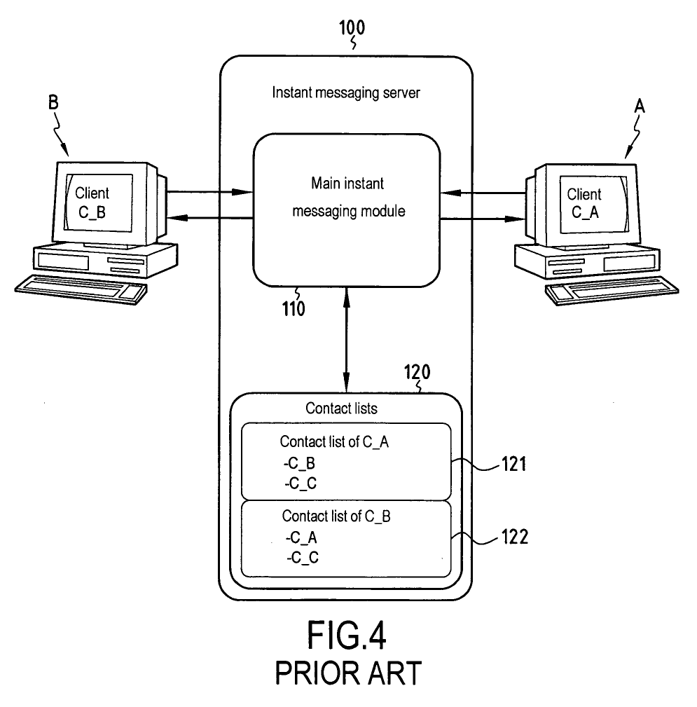

FIG. 2 shows one example of setting filter parameters and represents a type of interface that may be used by the user A from FIG. 1 to set up filtering of messages from the user B that are forwarded to the user C, who may be the secretary of A, for example. In FIG. 2, the user A decides to filter messages coming from the user B by selecting the “parameter a filter” option for the contact “user B” in his contact list. Once the option has been selected, a “forward this contact to:” window is displayed to enable the user A to define the user to whom messages from the user B must be forwarded, namely the user C in the present example. From this moment, all instant messages coming from the user B addressed to the user A will be forwarded to the user C.

One embodiment of the method of the invention used in the FIG. 1 system is described next, in which the various steps operative when filtering an instant message are represented by arrows S1 to S7. The method of the invention naturally comprises a preliminary step of setting the parameters of one or more filters in a contact list with associated filtering rules, as explained above.

The implementation described is based on the following hypotheses:

the user B of the instant messaging client C_B is included in the contact list of the instant messaging client C_A, and vice versa;

the user C of the instant messaging client C_C is included in the contact list of the instant messaging client C_A, and vice versa; and

the user A of the instant messaging client C_A has decided to forward messages from the instant messaging client C_B to the instant messaging client C_C.

This implementation example is described with reference to the XMPP protocol.

In a first step S1, the user B wishes to communicate with the user A by sending from his instant messaging client C_B an instant message addressed to the instant messaging client C_A. The instant message reaches the filter 230 and is of the type:
<xmpp sender=“C_B” addressee=“C_A” msg=“Hello Mr A”/>

The filter module 230 consults the main instant messaging module 210 to determine if a filter exists in the contact list 221 of the instant messaging client C_A that is the addressee of the message. The main module 210 discovers in the contact list 221 that any message emanating from the instant messaging client C_B must be filtered and forwarded to the instant messaging client C_C (step S2).

The main module 210 communicates this information to the filter module 230, which modifies the attribute message msg and changes the addressee from C_A to C_C, which yields:

<xmpp sender=”C_B” filtered by=”C_A” addressee=”C_C”
msg=”Message for A: Hello Mr A”/>

The message modified in this way is then sent to the main module 210 (step S3).

The instant messaging client C_C may also have specified a filter in its contact list 223. The filter module 230 consults the main module 210 again to determine if the instant messaging client C_C has specified a filter on the last sender mentioned in the message, namely the instant messaging client C_A in this example. The filter module 230 looks at the information “filtered by” first (i.e. before the initial sender) so that the filter is applied to client who last filtered the message and not to the sender, like the first time. If the instant messaging client C_C has actually specified a filter to filter messages from instant messaging client C_A to another instant messaging client, for example the instant messaging client C_D, the message becomes:

<xmpp sender=”C_B” filtered by=”C_C” addressee=”C_D”
msg=”Message for A: Hello Mr A”/>

The content of the message, i.e. the field msg, is modified only on the first filtering and remains the same during subsequent filtering.

The above procedure is repeated recurrently until the main module 210 finds no further filter in relation to the instant messaging client in the contact list of the addressee that last filtered the message, who then becomes the final addressee of the message.

For simplicity, the example described here considers that instant messaging client C_C has not specified a filter. Accordingly, in the next step S4, the main instant messaging module 210 sends this message to the instant messaging client C_C, who receives it with the modified text, as shown in FIG. 3.

Once the message has been received by the user C, conversation takes place. As shown in FIG. 3, the instant messaging client C_C composes a response that is sent to the instant messaging server 200. This response is contained in a message of the following type:

<xmpp sender=”C_C” addressee=”C_B” msg=”Mr A is not
available at the moment, can I help you ?/>

The message is received by the filter module 230, which if necessary processes it by looking up any filtering rules associated with the instant messaging client C_B (step S5).

The message is then sent to the main module 210 (step S6) which forwards it to the instant messaging client C_B (step S7).

The exchange of instant messages between the instant messaging clients C_B and C_C then continues normally, like a standard instant message, i.e. with no other processing by the filter module.

Thus the present invention offers an instant messaging user the possibility of activating and setting the parameters of filters in his contact list in order to designate instant messaging clients from whom he does not wish to receive messages and to redirect messages from those messaging clients to a third person of his choice, in order to ensure they do not go unanswered. The invention makes available to instant messaging users the call filtering and forwarding functions that exist already in the field of telephony.

What is claimed is:

1. A method of filtering messages in an instant messaging server comprising a main instant messaging module connected to an information base containing instant messaging clients' contact lists with associated filtering rules, said method comprising the following steps:
a) a first instant messaging client sending a messaging whereof the addressee is a second instant messaging client;
b) consulting the contact list of the second instant messaging client to verify if filtering of messages from the first instant messaging client is specified in said list;
c) in the event of positive verification, replacing the addressee of the message by a third instant messaging client and forwarding the message to that third instant messaging client; or
d) in the event of negative verification, sending the message to the second instant messaging client.

2. A method according to claim 1, wherein the instant messaging server further comprises a filter module which, in the step b), sends a query to the main instant messaging module to determine the filtering rules present in the contact list of the second instant messaging client.

3. A method according to claim 2, wherein, in the step c), the third instant messaging client replacing the addressee of the message is determined as a function of filtering rules specified in the contact list of the second instant messaging client.

4. A method according to claim 2, wherein, in the step c), the filter module modifies the content of the message to inform the third instant messaging client of the change of addressee.

5. A method according to claim 1, further comprising a step of consulting the contact list of the third instant messaging server to verify if filtering of messages from the second instant messaging client is specified in said list and, in the event of positive verification, a step of replacing the addressee of the message by another instant messaging client and sending the message to that other instant messaging client, these two steps being repeated until no further filtering is found in the contact list of the addressee of the message in relation to the instant messaging client who last filtered the message.

6. A method according to claim 2, wherein, in the step c), the filter module sends the message to the main instant messaging module which forwards said message to the addressee indicated therein.

7. An instant messaging sever comprising a main instant messaging module for managing the exchange of instant messages between instant message clients, wherein said main instant messaging module is connected to an information base containing instant messaging clients' contact lists and associated filtering rules and further comprises a filter module for filtering messages sent by a first instant messaging client to a second instant messaging client and for forwarding said messages to a third instant messaging client.

8. A server according to claim 7, wherein the third instant messaging client to whom messages sent by the first instant messaging client are forwarded is determined as a function of filtering rules specified in the contact list of the second instant messaging client.

9. A server according to claim 7, wherein the filter module further comprises means for modifying the content of a forwarded message to inform the third instant messaging client of the change of addressee.

10. An instant messaging system comprising at least three instant messaging clients connected to at least one instant messaging server according to claim 6.

11. A system according to claim 10, wherein the instant messaging clients comprise interface means for configuring at least one filter in their respective contact list.

12. A filter module adapted to be used in an instant messaging server comprising a main instant messaging server for managing the exchange of instant messages between instant messaging clients, wherein said filter module comprises means for filtering messages sent by a first instant messaging client to a second instant messaging client and for forwarding said messages to a third instant messaging client.

13. A module according to claim 12, further comprising means for modifying the content of a forwarded message to inform the third instant messaging client of the change of addressee.

14. A computer program adapted to be executed on an instant messaging server managing the exchange of instant messages between instant messaging clients, wherein the program comprises instructions for filtering messages sent by a first instant messaging client to a second instant messaging client and for forwarding said messages to a third instant messaging client.

15. A program according to claim 14, further comprising instructions for modifying the content of a forwarded message to inform the third instant messaging client of the change of addressee.
